(19) United States
(12) Patent Application Publication
(10) Pub. No.: US 2001/0014148 A1
(43) Pub. Date: Aug. 16, 2001

(54) APPARATUS WITH A STATIONARY FACSIMILE UNIT AND A CORDLESS HANDHELD UNIT WHICH INTEGRATES A SCANNER AND A SPEECH CIRCUIT

(76) Inventor: MASAHIRO IKEDA, SHIZUOKA (JP)

Correspondence Address: OSTROLENK FABER GERB & SOFFEN, 1180 AVENUE OF THE AMERICAS, NEW YORK, NY, 100368403

(21) Appl. No.: 09/238,103

(22) Filed: Jan. 27, 1999

(30) Foreign Application Priority Data
Jan. 28, 1998 (JP) 10-015553

(51) Int. Cl. H04M 11/00; H04N 1/00

(52) U.S. Cl. 379/100.02; 358/400

(57) ABSTRACT

In a communication apparatus, a stationary unit is connected to an exchange line and a cordless unit is connected to the stationary unit via a two-way radio link. The stationary unit has a printer and is arranged to receive a facsimile signal from the line and operate the printer. If a facsimile signal is received from the cordless unit, the printer is operated if a copy mode signal is also received or the received facsimile signal is transmitted to the line if a transmit mode signal is also received. The stationary unit is further arranged to receiver either an incoming call from the exchange line or an outgoing call from the cordless unit and establish a connection between the line and the cordless unit. The cordless unit has a keypad for entering a command, a scanner for scanning a document to produce a facsimile signal, and a telephone speech circuit. The cordless unit is responsive to a first command for transmitting the copy mode signal and the facsimile signal of the scanner to the stationary unit, responsive to a second command for transmitting the transmit mode signal and the facsimile signal of the scanner to the stationary unit, and responsive either to an indication of the outgoing call or an indication of the incoming call for connecting the telephone circuit to the exchange line.

### BACKGROUND OF THE INVENTION

1. Field of the Invention

The present invention relates to a communication apparatus in which facsimile and telephone units are combined.

2. Description of the Related Art

In a prior art communication apparatus as shown and described in Japanese Laid-Open Patent Specification Hei-5-308451, a stationary unit has a facsimile unit and a main telephone unit which is connected to the exchange line via a line interface such as modem. A number of cordless extension telephones are also provided. A radio link is established between each cordless telephone and the exchange line via the main telephone when there is an incoming or an outgoing call to or from the cordless unit. A cordless handheld scanner is detachably attached to the stationary unit. A radio link is established between the scanner and the facsimile unit during a copy mode or a transmit mode. Since there is only one radio channel assigned to the apparatus, when the user wishes to use the scanner during the time a cordless unit is being used, it is necessary to store the output signal of the scanner in a buffer memory until the end of the call.

One disadvantage of the prior art is that, since all units of the apparatus are physically separated from each other, each unit must be provided with a power supply unit. It is thus desirable to reduce the total cost of the power units.

Another disadvantage of the prior art is that the use of the main telephone and the cordless telephones together with the buffer memory results in a low cost performance if the cordless scanner is used with a much higher usage rate than the usage rate of the cordless telephones.

### SUMMARY OF THE INVENTION

It is therefore an object of the present invention to provide a high cost performance communication apparatus for both facsimile and telephone modes of communication.

According to one aspect of the present invention, there is provided a communication apparatus comprising a stationary unit connected to an exchange line and a cordless unit connected to the stationary unit via a two-way radio link. The stationary unit is arranged to receive a facsimile signal from the exchange line and print the received facsimile signal, receive a facsimile signal from the cordless unit and print or transmit the received facsimile signal to the exchange line depending on a control signal from the cordless unit, and is further arranged to receive either an incoming call from the exchange line or an outgoing call from the cordless unit and establishing a connection between the exchange line and the cordless unit. The cordless unit comprises a scanner for scanning a document to produce a facsimile signal and a telephone speech circuit. The cordless unit is arranged to transmit the facsimile signal of the scanner and the control signal to the stationary unit when the cordless unit is exclusively in a document scan mode, and connect the telephone circuit to the exchange line when the cordless unit is exclusively in a telephone speech mode.

According to a second aspect, the present invention provides a communication apparatus comprising a stationary unit connected to an exchange line and a cordless unit connected to the stationary unit via a two-way radio link. The stationary unit comprises a printer and is arranged to receive a facsimile signal from the exchange line and control the printer to print the received facsimile signal, receive a facsimile signal from the cordless unit and control the printer to print the received facsimile signal if a copy mode signal is also received from the cordless unit or transmit the received facsimile signal to the exchange line if a transmit mode signal is also received from the cordless unit. The stationary unit is further arranged to receive either an incoming call from the exchange line or an outgoing call from the cordless unit and establish a connection between the exchange line and the cordless unit. The cordless unit comprises command input means, a scanner for scanning a document to produce a facsimile signal, and a telephone speech circuit. The cordless unit is responsive to a first command from the command input means for transmitting the copy mode signal and the facsimile signal of the scanner to the stationary unit, responsive to a second command from the command input means for transmitting the transmit mode signal and the facsimile signal of the scanner to the stationary unit, and responsive either to an indication of the outgoing call or an indication of the incoming call for connecting the telephone circuit to the exchange line.

Since the scanner and the telephone speech circuit are integrated in a cordless unit, only one power supply unit such as rechargeable battery is needed.

Preferably, the telephone speech circuit comprises a microphone and a loudspeaker to provide a hands-free mode of communication.

### BRIEF DESCRIPTION OF THE DRAWINGS

The present invention will be described in further detail with reference to the accompanying drawings, in which:

FIG. 1 is a top plan view of a facsimile terminal according to the present invention;

FIG. 2 is a block diagram of the stationary unit of the facsimile terminal;

FIG. 3 is a block diagram of the cordless unit of the facsimile terminal; and

FIGS. 4A and 4B are flowcharts of the operation of the controller of the cordless unit according to the present invention.

### DETAILED DESCRIPTION

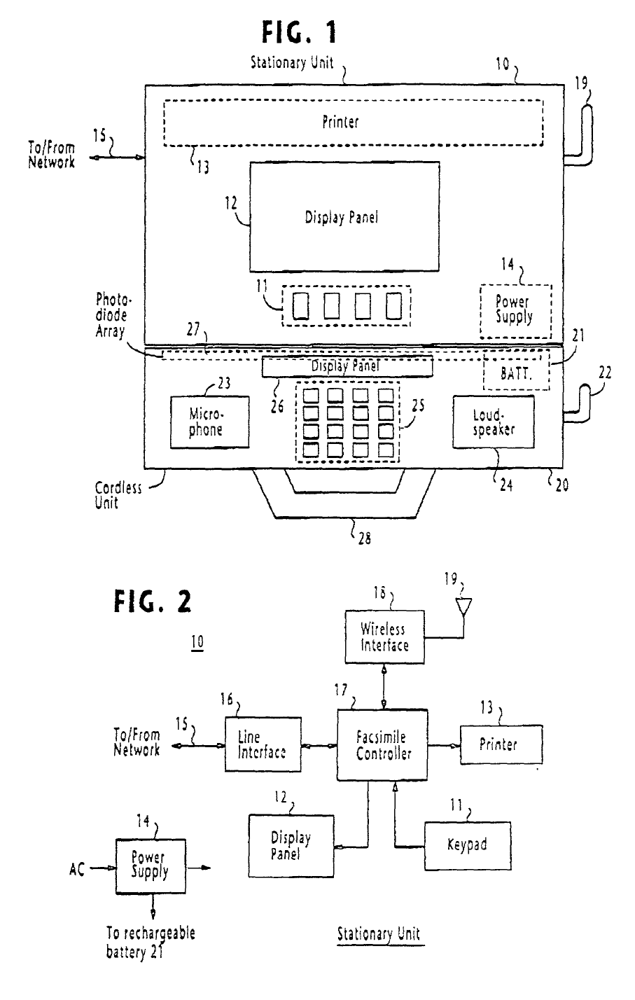

In FIG. 1, there is shown a communication apparatus according to the present invention. The apparatus generally comprises a stationary unit 10 with a power supply unit 14 and a cordless handheld unit 20 with a rechargeable battery 21. Cordless unit 20 is detachably coupled to the stationary unit 10 by means of a plug-socket joint or a suitable means to receive d.c. power from the power supply unit 14 for charging the rechargeable battery 21.

Stationary unit 10 has on its upper surface a keypad 11 for entering data and a display panel 12 for displaying entered information. A printer 13 is provided to produce a printout of facsimile data received from a distant facsimile terminal via an exchange line 15 or a copy of a document scanned by the cordless unit 20. Communication between units 10 and 20 is via a two-way wireless link established between antennas 19 and 22.

Cordless unit 20 is a combined scanner and telephone unit, which is attached side-by-side to the stationary unit during a standby mode or battery-charging mode as illustrated in FIG. 1. Cordless unit 20 is housed in a rectangular case which is formed with a hand-grip portion 28 with which the user can pull the cordless unit 20 away from the stationary unit 10 and place it on a document to be scanned.

On the upper surface, the cordless unit 20 is provided with a microphone 23 on one side and a loudspeaker 24 on the other side, between which is a keypad 25 to enter a mode command that specifies one of predefined operating modes and address (telephone number) digits. A display panel 26 is also provided for the convenience of the user to confirm data entered through the keypad 25.

Inside the housing of cordless unit 20 is a linear array 27 of photodiodes. Photodiode array 27 is open to the outside to scan across the width of a light-illuminated document and convert reflecting light into an electrical signal as the array slides past successive lines when the user moves the cordless unit along the length of the document.

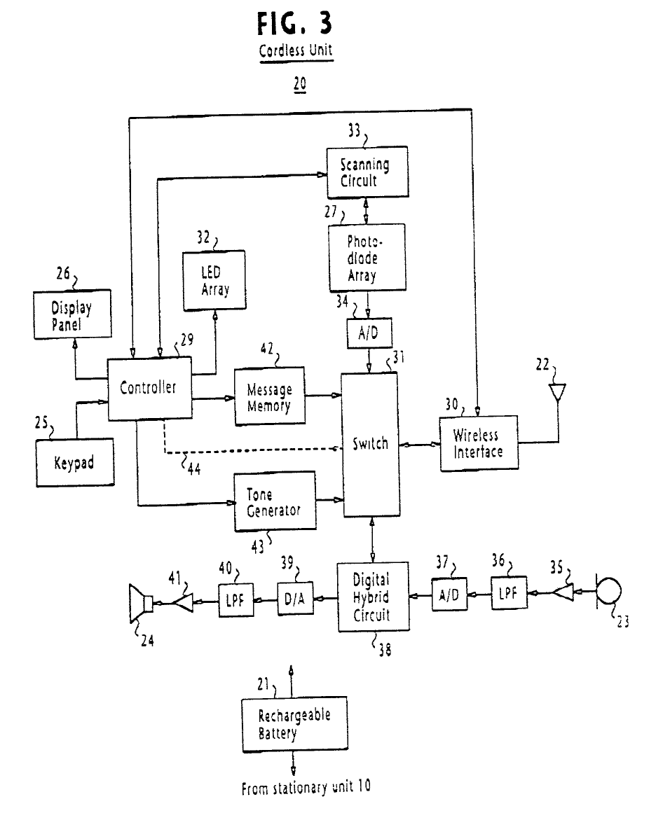

As shown in FIG. 2, the stationary unit 10 has a line interface 16 for interfacing the exchange line 15 to a facsimile controller 17, which is connected to a radio frequency transmit/receive unit, or wireless interface 18 which transmits and receives radio signals to and from the antenna 19 and converts a received RF signal to baseband. Facsimile controller 17 receives a network signal from the line interface 16 to control the printer 13 to produce a print-out if the received signal is facsimile data. If the network signal indicates that a telephone call is received, the facsimile controller 17 commands the wireless interface 18 to establish a two-way radio link with the cordless unit 20 to allow the line interface 16 and the wireless interface 18 to exchange remote and local speech signal.

As will be described in detail later, the facsimile controller 17 further receives a mode command signal from the cordless unit via the wireless interface 18. If the mode command indicates that the user wishes to send a telecopy of a document to a distant terminal or and wishes to place a call to a distant telephone, the facsimile controller 17 commands the line interface 16 to establish a switched connection in the communication network. If the mode command is a copy mode signal, the facsimile controller 17 controls the printer 13 to produce a copy of a scanned document. Facsimile controller 17 is also responsive to data entered through the keypad 11 for displaying the entered data on the display panel 12.

Power supply unit 14 converts commercial the a.c. mains voltage to a d.c. voltage and feeds the rechargeable battery 21 of the cordless unit as well as all circuit components of the stationary unit 10.

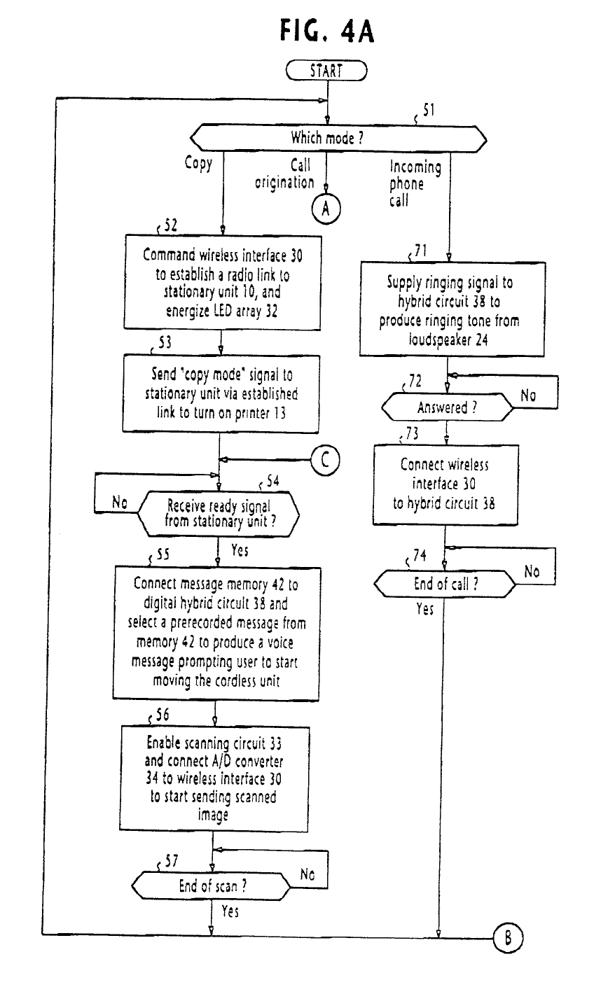

Details of the cordless unit 20 are shown in FIG. 3. Cordless unit 20 comprises a controller 29 connected to the keypad 25, a wireless interface 30, a switch 31, an LED (light-emitting diode) array 32 and a scanning circuit 33 which controls the photodiode array 27. The output of the photodiode array 27 is connected to an A/D converter 34 whose output can be applied through the switch 31 to the wireless interface 30 and thence to the antenna 22 under control of the controller 29. Wireless interface 30 can also be connected to the two-wire section of a digital hybrid circuit 38 under control of the controller 29. Digital hybrid circuit 38 is a well-known four-wire two-wire converter where its four-wire section has an input and an output terminal. Sound signal picked up by the microphone 23 is amplified by an amplifier 35, filtered through an anti-aliasing (lowpass) filter 36 and converted to a digital signal by an A/D converter 37, and applied to input terminal of the digital hybrid circuit 38. The output terminal of the hybrid circuit 38 is connected to a D/A converter 39 where digital signals from the switch 31 are converted to analog signals, filtered through a lowpass filter 40, amplified by an amplifier 41, and applied to the loudspeaker 24.

A message memory 42 is further provided for storing prerecorded messages and the controller 29 reads an appropriate message from this memory. This message is supplied through the switch 31 to the hybrid circuit 38 to produce a vocal announcement from the loudspeaker 24.

A digital tone generator 43 is provided to producc a digital ringing signal in response to the controller 29 when an incoming call is received from the network. Tone generator 43 is connected to the switch 31 for coupling the ringing signal to the hybrid circuit 38 to produce a ringing tone from the loudspeaker 24.

Switch 31 is controlled through a line 44 by the controller 29 to establish a path between a pair of any circuits connected to it.

All circuit components of the cordless unit 20 are energized by the rechargeable battery 21.

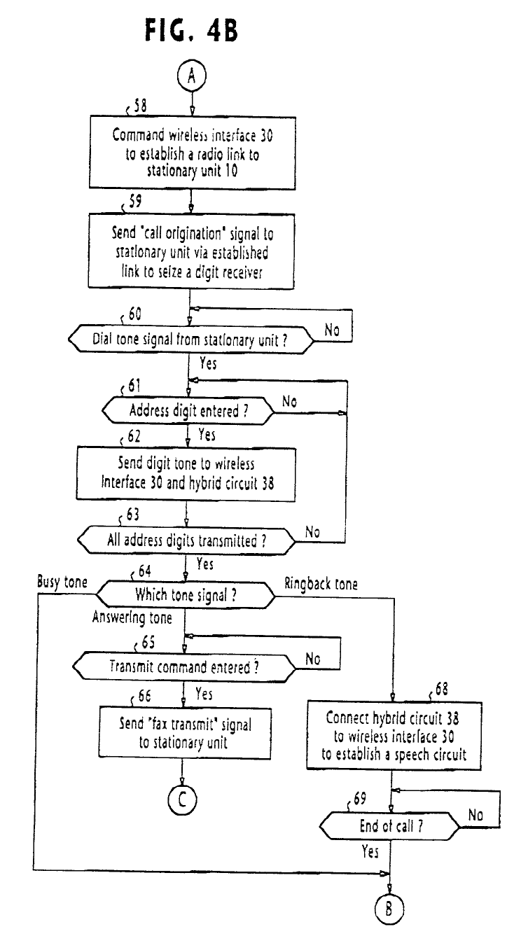

The operation of the controller 29 of cordless unit 20 will be described with the aid of the flowcharts of FIGS. 4A and 4B.

In FIG. 4A, the operation of the controller 29 begins with step 51 in which it identifies the mode of signal it is receiving from the keypad 25 or the wireless interface 30. If the user detaches the cordless unit 20 from the stationary unit 10, place it an a document to be copied, and enters a “copy mode” command through the keypad 25, the controller proceeds from step 51 to step 52 where it commands the wireless interface 30 to establish a radio link between the cordless and stationary units and energizes the LED array 32 to illuminate the document.

At step 53, the controller 29 sends a “copy-mode” signal to the stationary unit via the established radio link to cause the printer 13 to be turned on. When the printer 13 is set in a condition ready to print, the stationary unit 10 returns a receive ready signal to the cordless unit via the radio link. Controller 29 responds to this receive ready signal at step 54 and proceeds to step 55 to connect the message memory 42 to the hybrid circuit 38 and read a pre-recorded message out of the memory 42. As a result, the loudspeaker 24 produces a vocal announcement prompting the user to start moving the cordless unit on the document.

At step 56, the controller 29 enables the scanning circuit 33 to cause the photodiode array 27 to scan across the width of the document, and connects the A/D converter 34 to the wireless interface 30 to start sending a coded signal of a scanned image to the printer 13 of the stationary unit. A copy of the document is thus produced on the printer 13. When the scanning operation ends (step 57), flow returns to step 51.

If the user wishes to send a facsimile or place a telephone call, a “call origination” command is entered through the keypad 25. In response, the controller 29 proceeds from step 51 to step 58 to command the wireless interface 30 to establish a radio link to the stationary unit 10. At step 59, the controller 29 sends a “call origination” signal to the stationary unit via the established radio link to cause the line interface 16 to seize a digit receiver in the communications network. If dial tone is received from the network, the stationary unit relays it to the cordless unit producing a dial tone from the loudspeaker 24. Controller 29 recognizes, at step 60, that the network is ready to accept address digits and start counting the number of digits which will be entered by the user through the keypad 25. When the user enters a digit of a destination, it is applied through the controller 29 to the wireless interface 30, transmitted to the stationary unit and forwarded onto the exchange line 15 from the line interface 16 (step 62).

Steps 61 and 62 are repeated until all address digits of the destination are entered and transmitted to the network (step 63). A switched connection is thus established through the communication network to the destination. If the mode of call origination is a facsimile transmission, the user has placed the cordless unit on a document to be sent and the destination is a facsimile terminal returning an answering tone through the network, thus prompting the user to enter a “fax transmit” command through the keypad 25. If the transmit command is entered (step 65), the controller 29 proceeds to step 66 to send a “fax transmit mode” signal to the stationary unit and returns to step 54 to repeat steps 55 to 57 after a receive ready signal is received from the stationary unit. When the document is successfully sent to the destination fax terminal, the controller 29 returns from step 57 to step 51.

If the user wishes to place a telephone call, the destination is a telephone set and thus a ringback tone is returned from the network. In this instance, the controller 29 proceeds from step 64 to step 68 to connect the hybrid circuit 38 to the wireless interface 30. A speech circuit is thus established between the calling party and the destination. When the call terminates, flow returns from step 69 to step 51.

If the destination terminal has been in use when all digits are sent to the network, a busy tone is received from the network and the controller 29 returns from step 69 to step 51.

If an incoming call is received from the network, the controller 17 of the stationary unit is informed of this fact by the line interface 16. Controller 17 causes the wireless interface 18 to establish a radio link to the cordless unit and sends a “call arrival” signal to the controller 29. In response, the controller 29 proceeds from step 51 to step 70 to produce a ringing signal, which is coupled through the switch 31 to the hybrid circuit 38 to produce a ringing tone from the loudspeaker 24 to alert the user. When the user answers the call by pressing an answer key on the keypad 25 (step 72), the controller 29 proceeds to step 73 to connect the wireless interface 30 to the hybrid circuit 38 to establish a speech circuit. At the end of the call, the controller 29 returns from step 74 to step 51.

When the incoming call is directed to the stationary unit for receiving a telecopy from a remote terminal, the controller 17 operates the printer 13 in the usual manner. No radio link is thus established during this mode.

What is claimed is:

1. A communication apparatus comprising a stationary unit connected to an exchange line and a cordless unit connected to the stationary unit via a two-way radio link,
the stationary unit receiving a facsimile signal from the exchange line and printing the received facsimile signal, receiving a facsimile signal from the cordless unit and printing the received facsimile signal or transmitting the received facsimile signal to the exchange line depending on a control signal from the cordless unit, and receiving either an incoming call from the exchange line or an outgoing call from the cordless unit and establishing a connection between the exchange line and the cordless unit,
the cordless unit comprising a scanner for scanning a document to produce a facsimile signal and a telephone speech circuit, the cordless unit transmitting the facsimile signal of the scanner and said control signal to the stationary unit when the cordless unit is exclusively in a document scan mode, and connecting the telephone circuit to the exchange line when the cordless unit is exclusively in a telephone speech mode.

2. The communication apparatus of claim 1, wherein said telephone speech circuit comprises a microphone and a loudspeaker.

3. The communication apparatus of claim 1, wherein said cordless unit comprises a single power supply unit for supplying d.c. power to said scanner and said telephone speech circuit.

4. The communication apparatus of claim 1, wherein said power supply unit is a rechargeable battery detachably connected to the stationary unit to receive d.c. power therefrom.

5. A communication apparatus comprising a stationary unit connected to an exchange line and a cordless unit connected to the stationary unit via a two-way radio link,
the stationary unit comprising a printer, the stationary unit receiving a facsimile signal from the exchange line and controlling the printer to print the received facsimile signal, receiving a facsimile signal from the cordless unit and controlling the printer to print the received facsimile signal if a copy mode signal is also received from the cordless unit or transmitting the received facsimile signal to the exchange line if a transmit mode signal is also received from the cordless unit, and receiving either an incoming call from the exchange line or an outgoing call from the cordless unit and establishing a connection between the exchange line and the cordless unit,
the cordless unit comprising command input means, a scanner for scanning a document to produce a facsimile signal, and a telephone speech circuit, the cordless unit being responsive to a first command from the command input means for transmitting said copy mode signal and the facsimile signal of the scanner to the stationary unit, responsive to a second command from the command input means for transmitting said transmit mode signal and the facsimile signal of the scanner to the stationary unit, and responsive either to an indication of said outgoing call or an indication of said incoming call for connecting the telephone circuit to the exchange line.

6. The communication apparatus of claim 5, wherein said telephone speech circuit comprises a microphone and a loudspeaker.

7. The communication apparatus of claim 5, wherein said cordless unit comprises a single power supply unit for supplying d.c. power to the scanner and the telephone speech circuit.

8. The communication apparatus of claim 5, wherein said power supply unit is a rechargeable battery detachably connected to the stationary unit to receive d.c. power therefrom.

9. The communication apparatus of claim 5, wherein said cordless unit includes means for producing a vocal announcement for prompting a user to start moving the cordless unit on a documen when said printer is ready to operate after said copy mode signal or said transmit mode signal is sent to the stationary unit.
